(19) United States
(12) Patent Application Publication
(10) Pub. No.: US 2021/0341299 A1
(43) Pub. Date: Nov. 4, 2021

(54) E-HAILING SERVICE

(71) Applicant: GRABTAXI HOLDINGS PTE. LTD., Singapore (SG)

(72) Inventors: Renrong WENG, Singapore (SG); Yang CAO, Singapore (SG); Sien Yi TAN, Singapore (SG); Kong-Wei LYE, Singapore (SG); Swara DESAI, Singapore (SG); Liuqin YANG, Singapore (SG); Sizhe ZHANG, Singapore (SG)

(73) Assignee: GRABTAXI HOLDINGS PTE. LTD., Singapore (SG)

(21) Appl. No.: 17/271,260

(22) PCT Filed: Aug. 31, 2018
(86) PCT No.: PCT/SG2018/050443

§ 371 Date: Feb. 25, 2021

(51) Int. Cl. G01C 21/34; G06F 17/18; G06N 3/04; G06Q 10/02

(52) U.S. Cl. CPC G01C 21/3438; G06Q 10/02; G06N 3/0445; G06F 17/18

(57) ABSTRACT

Example embodiments relate generally to methods, systems, and devices for managing service providers and service requests. The method includes, for each identified geographical area, deriving a service request forecast and service provider forecast for a particular upcoming time period. The method includes, for each identified geographical area, determining whether the geographical area will be in an over-supply state during the particular upcoming time period. The method includes, for each identified geographical area determined to be in the over-supply state during the particular upcoming time period: determining a quantity M of available service providers; selecting at least M available service providers in the geographical area; and providing a notification to only the selected available service providers. Each notification may include a message to move out of the geographical area and into a particular location in another geographical area.

### TECHNICAL FIELD

The present invention lies in the field of transportation. Some embodiments relate to methods and apparatus for managing transport service providers.

### BACKGROUND

US20140011522 relates to a method for providing on-demand service information. One or more processors determine, for a given geographic region, position information for each of a plurality of requesters for an on-demand service and position information for each of a plurality of service providers that can provide the on-demand service. A plurality of sub-regions is identified for the given geographic region. Based, at least in part, on the position information of the requesters and the service providers, one or more sub-regions are determined as being under-supplied by the plurality of service providers as compared to one or more other sub-regions. Information identifying the under-supplied sub-regions are provided to one or more service provider devices.

### SUMMARY

Aspects of the invention are recited in the appended independent claims, with some features of some embodiments recited in dependent claims.

In one aspect there is disclosed a method of managing transport service providers, the method comprising:—receiving, in real-time, a first data flow, the first data flow comprising data indicative of each of plural service providers, said data comprising an indication of the identity of each of said service providers, availability data of the respective service provider and an indication of location of each respective service provider; processing the first data flow together with stored historical supply/demand data to provide a forecast at a given time of the number of service providers and number of services requests over an area comprising plural geographical zones, wherein the forecast is by zone; filtering the first data flow using availability criteria to provide output data indicative of candidate service providers, wherein the data indicative of each candidate service provider includes an indication of the identity of each candidate service provider associated with a location of the respective candidate service provider; combining the data indicative of candidate service providers with the forecast number of service providers and number of service requests and calculating therewith a distance/time matrix of candidate service providers moving to each different zone from their current zone, thereby to establish a set of candidate service providers eligible to be moved from their current zone to a respective new zone; and outputting a respective notification to only each eligible service provider, the notification comprising an indication of a new location in a new zone, whereby the number of service providers in at least some zones converges on the number of service requests.

In another aspect there is disclosed apparatus for managing transport service providers, comprising data storage and a processor operating under control of stored instructions to:—receive, in real time, a first data flow, the first data flow comprising data indicative of each of plural service providers, the data comprising an indication of the identity of each service provider, availability data of the respective service provider and an indication of location of each the respective service provider; read, from the storage, historical supply/demand data; process the first data flow together with the historical supply/demand data to provide a forecast of the number of service providers and number of services requests over an area comprising plural geographical zones, wherein the forecast is by zone; filter the first data flow using availability criteria to output data indicative of candidate service providers, wherein the data indicative of each candidate service provider includes an indication of the identity of each candidate service provider associated with a location of the respective candidate service provider; combine the data indicative of candidate service providers with the forecast number of service providers and number of service requests and calculate therewith a distance/time matrix of candidate service providers moving to each different zone from their current zone, thereby to establish a set of candidate service providers eligible to be moved from their current zone to respective new zone; and output a respective notification to only each eligible service provider, the notification comprising an indication of a new location in a new zone, whereby the number of service providers in at least some zones converges on the number of service requests.

There is also disclosed a method of managing a plurality of service providers and service requests. The method may include identifying a plurality of geographical areas. The method may include, for each of the identified geographical areas, deriving a service request forecast. Each service request forecast may include a forecast of a quantity of service requests that will be received for the geographical area for an upcoming first time period. The method may also include, for each of the identified geographical areas, deriving a service provider forecast. Each service provider forecast may include a forecast of a quantity of service providers in the geographical area that will be available to accept a service request during the upcoming first time period. The method may also include, for each of the identified geographical areas, determining whether the geographical area will be in an over-supply state during the upcoming first time period. Each geographical area may be in the over-supply state during the upcoming first time period when the service provider forecast for the geographical area for the upcoming first time period exceeds the service request forecast for the geographical area for the upcoming first time period by at least a first threshold value. The method may also include, for each identified geographical area that is determined to be in the over-supply state during the upcoming first time period, determining a quantity M of available service providers in the geographical area. The quantity M may be a quantity that, if deducted from the service provider forecast for the geographical area in the upcoming first time period, would result in the geographical area to not be in the over-supply state. The method may also include, for each identified geographical area that is determined to be in the over-supply state during the upcoming first time period, selecting at least M available service providers in the geographical area. The selecting of each available service provider may be based on one or more predetermined criterion.

The method may further include, for each identified geographical area that is determined to be in the over-supply state during the upcoming first time period, providing a notification to only the selected available service providers. Each notification may include a message to move out of the geographical area. Each notification may include a message to move into one or more other geographical areas. There is also disclosed a method of managing a plurality of service providers and service requests is described. The method may include identifying a plurality of geographical areas, including a first geographical area and a second geographical area. The method may include deriving a service request forecast for each of the first and second geographical areas. Each service request forecast may include a forecast of a quantity of service requests that will be received for the geographical area for an upcoming first time period. For example, each service request forecast may include, but is not limited to, one or more of the following: a forecast of a quantity of service requests that will be received for the geographical area during an upcoming first time period; a forecast of a quantity of service requests that will be received for the geographical area during an upcoming first time period that is requesting for services to be provided right away and/or during the upcoming first time period; a forecast of a quantity of service requests that will be received for the geographical area prior to an upcoming first time period that is requesting for services to be provided during the upcoming first time period; and/or a quantity of service requests that have already been received for the geographical area, such received service requests requesting for services to be provided right away (but have not yet been matched to an available service provider) and/or during the upcoming first time period. The method may also include deriving a service provider forecast for each of the first and second geographical areas. Each service provider forecast may include a forecast of a quantity of service providers in the geographical area that will be available to accept a service request during the upcoming first time period. The method may also include, for each of the identified geographical areas, determining whether the geographical area will be in an over-demand state, an over-supply state, or a normal state during the upcoming first time period. The over-demand state may be determined when the service request forecast exceeds the service provider forecast by at least a first threshold value. The over-supply state may be determined when the service provider forecast exceeds the service request forecast by at least a second threshold value. The normal state may be determined when neither the over-demand state nor the over-supply state is forecasted. The method may further include, responsive to the first geographical area being determined to be in the over-supply state during the upcoming first time period, determining a quantity M. The quantity M may be a quantity that, if deducted from the service provider forecast for the first geographical area in the upcoming first time period, would result in the first geographical area to change from the over-supply state to the normal state. The method may further include, responsive to the first geographical area being determined to be in the over-supply state during the upcoming first time period, selecting at least M available service providers in the first geographical area based on one or more predetermined criterion. Each selected available service provider may be a service provider that is forecasted to be available to accept a service request in the first geographical area in the upcoming first time period. The method may further include, responsive to the second geographical area being determined to be in the over-demand state during the upcoming first time period, determining a quantity N. The quantity N may be a quantity that, if added to the service provider forecast for the second geographical area in the upcoming first time period, would result in the second geographical area to change from the over-demand state to the normal state. The method may further include providing a notification to each of the selected available service providers to move out of the first geographical area. Alternatively, or in addition, each notification may include a message to move into one or more other geographical areas.

In another exemplary embodiment, a method of managing a plurality of service providers and service requests is described. The method may include identifying a plurality of geographical areas, including a first geographical area, a second geographical area, and one or more intermediate geographical areas. The method may also include deriving a service request forecast for each of the identified geographical areas. Each service request forecast may include a forecast of a quantity of service requests that will be received for the geographical area for an upcoming first time period. The method may also include deriving a service provider forecast for each of the identified geographical areas. Each service provider forecast may include a forecast of a quantity of service providers in the geographical area that will be available to accept a service request during the upcoming first time period. The method may also include, for each of the identified geographical areas, determining whether the geographical area will be in an over-demand state, an over-supply state, or a normal state during the upcoming first time period. The over-demand state may be determined when the service request forecast exceeds the service provider forecast by at least a first threshold value. The over-supply state may be determined when the service provider forecast exceeds the service request forecast by at least a second threshold value. The normal state may be determined when neither the over-demand state nor the over-supply state is forecasted. The method may also include, responsive to the first geographical area being determined to be in the over-supply state during the upcoming first time period, the second geographical area being determined to be in the over-demand state during the upcoming first time period, and the intermediate geographical areas to have one or more available service providers during the upcoming first time period, selecting at least one available service provider in the first geographical area based on one or more predetermined criterion. Each selected available service provider may be a service provider that is forecasted to be available to accept a service request in the first geographical area in the upcoming first time period. The method may also include, responsive to the first geographical area being determined to be in the over-supply state during the upcoming first time period, the second geographical area being determined to not be in the over-supply state during the upcoming first time period, and one or more of the intermediate geographical areas to not be in the over-supply state during the upcoming first time period, selecting at least one service provider in one or more of the intermediate geographical areas based on the one or more predetermined criterion. Each selected service provider in the one or more intermediate geographical areas may be a service provider that is forecasted to be available to accept a service request in the one or more intermediate geographical areas in the upcoming first time period. The method may also include, responsive to the first geographical area being determined to be in the over-supply state during the upcoming first time period, the second geographical area being determined to be in the over-demand state during the upcoming first time period, and the intermediate geographical areas to have available service providers during the upcoming first time period, providing a notification to only one or more of the selected available service providers in the first geographical area to move out of the first geographical area and into the one or more intermediate geographical area that have one or more available service providers during the upcoming first time period. The method may also include, responsive to the first geographical area being determined to be in the over-supply state during the upcoming first time period, the second geographical area being determined to be in the over-demand state during the upcoming first time period, and the intermediate geographical areas to have one or more available service providers during the upcoming first time period, providing a notification to only one or more of the selected service providers in the one or more intermediate geographical areas that have one or more available service providers during the upcoming first time period to move out of its geographical area and/or into the second geographical area.

Implementation of the techniques described herein may provide significant technical advantages by providing notification messages only to those who need it, thus avoiding confusion, while minimizing the amount of data being communicated thereby providing efficient and effective operation. The content of the messages may be such as to reduce time and/or distance for service providers to move to a near optimal minimum.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an illustration of an example of a user device configurable to send a service request;

FIG. 2 is an illustration of an example of a service provider computing device;

FIG. 3 is an illustration of an example embodiment of a system for managing service providers and service requests;

FIG. 4A is an illustration of an example embodiment of a plurality of geographical areas;

FIG. 4B is an illustration of another example embodiment of a plurality of geographical areas;

FIG. 4C is an illustration of another example embodiment of a plurality of geographical areas having forecasted states;

FIG. 5 shows a highly schematic view of a processor and data warehouse with their data flows;

FIG. 6 shows an example of historical spatial temporal demand supply data;

FIG. 7 shows an example of service provider profile data;

FIG. 8A shows an example of service requests data;

FIG. 8B shows an example of real time service provider status data;

FIG. 9 shows an example of real time third party data;

FIG. 10 shows an example of forecasted spatial temporal demand supply data;

FIG. 11A shows an example of real time service provider status data;

FIG. 11B shows an example of candidate service provider data;

FIG. 12 shows an example of historical aggregated temporal-spatial data;

FIG. 13 shows an example of an optimization result;

FIG. 14 shows an example of a displayed notification;

FIG. 15 shows an example message, with time of issue, ID of service provider receiving it and the content of it, in terms of “to” and “from”; and

FIG. 16 shows a highly schematic drawing of a packet.

### DETAILED DESCRIPTION

Recent history has seen a growth of transport-related services, that can be searched for, priced, compared, requested, reserved, booked, or cancelled directly or indirectly from a user device.

In the context of this document the term “transport-related services” includes public transportation, taxis, private car hires, limousine services, shuttles, ride-sharing, delivery.

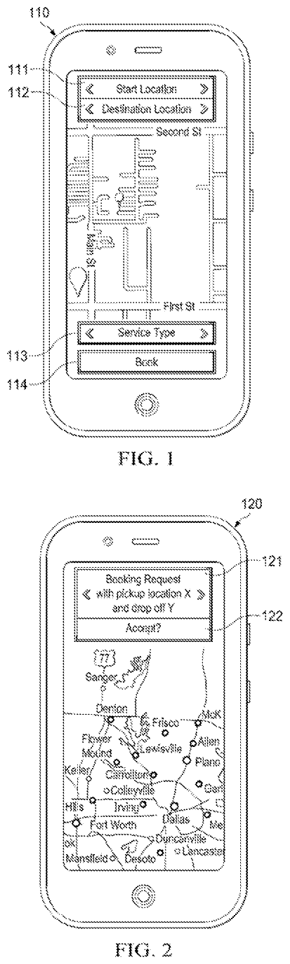

An illustrative example of a GUI (graphical user interface) on a smartphone acting as user device is shown in FIG. 1.

The illustrated GUI has: a section 111 for inputting a start or origin location for the service being requested; a section 112 for inputting a destination location for the service being requested; a section for selecting a service type (e.g., taxi, private car, ride-share or car-pool, shuttle, bus, delivery, etc.);

a map, which may include indications of a current location of the computing device of the user, the start or origin location for the service being requested, the end or destination location for the service being requested, or location of one or more available service providers; methods of payment; a button to submit a service request; estimated or guaranteed fare; estimated or guaranteed arrival time; favorite origin and destination locations; promotions; links to other features and functionality.

The invention is in no way limited to this or any other interface. The interface is shown in order to aid understanding.

A service provider may also use a software application, such as a mobile application, widget, or internet website, on a service provider device to enable the service provider to, among other things, receive, accept, ignore, or decline service requests that have been received via a communication network.

An illustrative example of a smartphone displaying a service provider GUI (graphical user interface) is shown in FIG. 2.

The illustrated service provider GUI has: a pop-up or notification section 121, which may provide one or more notifications, such as new service request(s) matched to or available to be accepted by the service provider; a section 122 that allows the service provider to accept a new service request; a map, which may include indications of a current location of the computing device of the service provider, the start or origin location for the service request received or accepted, and/or the end or destination location for the service request received or accepted; a navigation section for providing one or more directions, etc., for the service provider to travel from a current location of the computing device of the service provider to another location (e.g., destination, origin location of service request, location of computing device of the user, etc.).

As will be later described, embodiments of the service provider GUI incorporating the invention are configurable to display other fields, for example a notification field proposing that a service provider should move location, and a field allowing a user of the service provider GUI to accept such a proposal. See for example FIG. 14.

The invention is in no way limited to this or any other interface. The interface is shown in order to aid understanding.

Present approaches to managing transport-related services include receiving a service request, performing a search for suitable and available service providers nearby the location of the user (or start or origin location provided by the user), and matching a suitable and available service provider to the service request. While such an approach has generally been able to match service requests to suitable and available service providers, problems, including inefficient or non-optimal imbalances in supply (available service providers) or demand (received service requests), may be encountered.

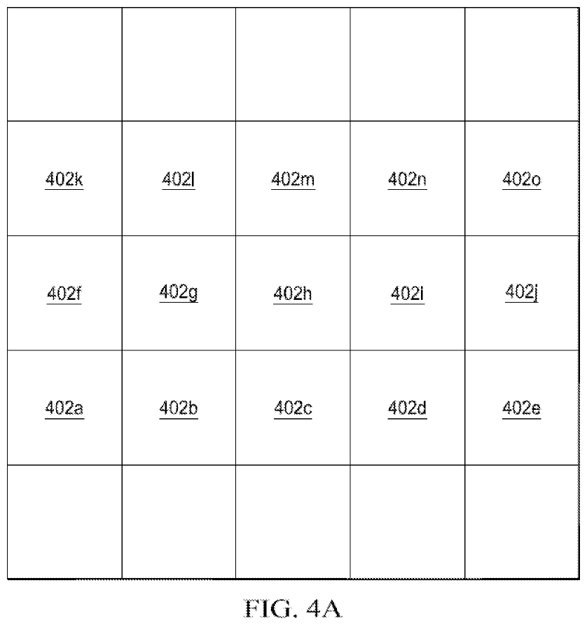

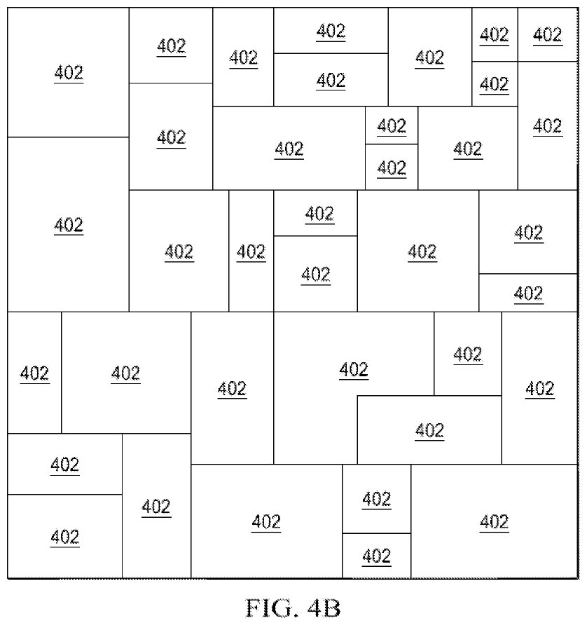

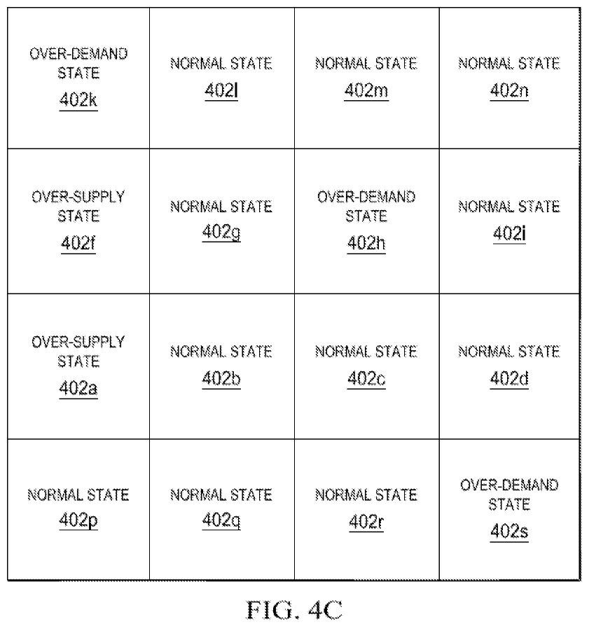

For illustrative purposes, geographical areas 402a-402o illustrated in FIG. 4A and geographical areas 402a-402s illustrated in FIG. 4C, may exist and/or be pre-assigned or pre-designated for a given larger geographical area (e.g., a region, district, town, city, state, province, etc.). Although the geographical areas illustrated in FIGS. 4A and 4C are shown to be evenly divided in terms of size and/or shape, it is to be understood in the present disclosure that geographical areas may differ in size and/or shape, such as the geographical areas 402 illustrated in FIG. 4B.

As an exemplary illustration of an imbalance situation, a quantity of available service providers in, say geographical area 402a exceeds a quantity of service requests received (e.g., received service requests that have a start location in area 402a). In such a situation, hereinafter referred to as an “over-supply state” or “under-demand state”, there are available service providers in area 402a who may remain available and unmatched to service requests for extended periods of time.

As another example illustration of an imbalance situation, the number of service requests that have a start location area 402s exceeds the number of available service providers in area 402s. In such a situation, hereinafter referred to as an “over-demand state” or “under-supply state”, there may be many service requests having start locations in that particular geographical area (e.g., geographical area 402s) who will remain unmatched to available service providers for extended periods of time.

### Example Embodiments of a System for Managing Service Requests and Service Providers

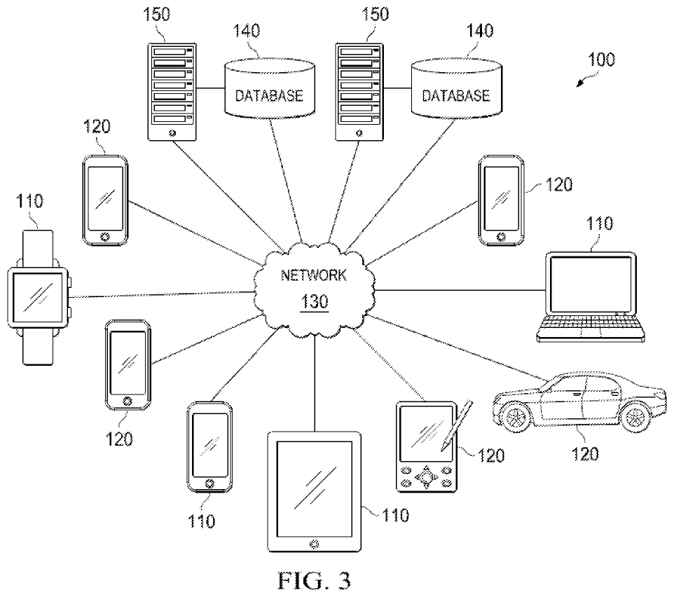

As an overview, an example embodiment of a system 100 for managing a plurality of service requests is illustrated in FIG. 3 and will now be described. The system 100 includes one or more processors 150. As used in the present disclosure, when applicable, a reference to a processor may also refer to, apply to, or include a computing device, server, cloud-based computing, or the like, or functionality of a processor, computing device, server, cloud-based computing, or the like. The system 100 includes one or more databases (e.g., database 140). As used in the present disclosure, when applicable, a reference to a database may also refer to, apply to, or include database systems, database management systems, cloud-based computing, cloud-based storage, storage systems and devices, block chain-related technologies and system, or the like. The system 100 includes plural user devices 110 for sending of service requests, sending of a location (e.g., start location or current location) of the computing device, and/or one or more of the actions, processes, and/or functionalities described in the present disclosure. The system 100 also includes service provider devices 120 configurable or configured to receive service requests, send a location (e.g., current location of the service provider device), receive notifications of matches with service requests, receive other notifications as described in the present disclosure, and/or one or more of the actions, processes, and/or functionalities described in the present disclosure. In some example embodiments, a service provider device 120 is associated or integrated with a vehicle of the service provider or is a part of an autonomous or semi-autonomous vehicle performing the services of a service provider. The processors 150, databases 140, user devices 110, and service provider devices 120 are in communication with one another via one or more networks 130, such as the Internet, World Wide Web, one or more private networks, or the like. In some example embodiments, such communication may also be a direct or indirect communication between a user device 110 and service provider device 120, such as in the case of street-hailing services (e.g., direct or line-of-sight range, within Wi-Fi range, within Bluetooth range, within audio signal range, or via in-person hailing of service providers by a user).

In use in an embodiment, the processor(s) 150 loop in an idle state until a user request is received from a user device 110. The request causes an interrupt to the processor which then resorts to a receive state to take in data from the user request. This data forms a data flow of real-time parameters as will be described below. In this and some other embodiments, the service provider devices 120 run one or more software applications which cause them to push data to the processor(s) 150 when the service provider changes his state. Examples of state change are when the service provider comes online or picks up/sets down or changes from unavailable to available. The same or different application in some embodiments responds to processor requests on a regular or irregular basis (for example at a standard interval) to send data, for example service provider state and location, back to the processor. Data pushed from the service provider devices causes an interrupt to the processor idle state, and the processor then resorts to a receive state to take in data from the service provider device which form a data flow of real-time parameters as will be described below. On the other hand, requests by the processor to a service provider device is arranged in some embodiments to interrupt a processor of the service provider device so that this device is caused to return the required data to the system processor.

Referring to FIG. 3, the system has user devices 110 and service provider devices 120. User devices are for use by users (e.g., those who send service requests) and service provider devices are for use by those who provide services requested by users or user devices Both user and provider devices are typically smartphones, but may be any computing device, mobile computing device, processor, controller, or the like, configurable or configured to perform processing of information, communicate via wired and/or wireless communications, or any of the other actions, processes, or functionalities described in the present disclosure. The devices 110, 120 may be configurable or configured to perform wireless communications through 3G networks, 4G networks, 4G LTE networks, or the like, such as via a SIM card installed in the device 110,120 or the like. In addition to or alternatively, the devices 110,120 may be configurable or configured to perform wireless communications via WLANs, such as Wi-Fi networks and Li-Fi networks, or via other forms, such as Bluetooth, NFC, and other forms of wireless signals.

User devices 110 may be configurable or configured (e.g., via software, such as a mobile application, installed on the device) to communicate, wirelessly or via wires, with the processor 150 and such communications may include sending service requests, sending locations, viewing available service providers and fees, and receiving notifications. Such service requests are typically sent using a packet communication system with a header field indicating a packet destination and payload fields containing the actual data content.

Service provider devices 120 may be configurable or configured (e.g., via software, such as a mobile application, installed on the service provider computing device) to communicate, wirelessly or via wires, with the processor 150 and such communications may include receiving service requests that need to be serviced, sending locations, receiving notifications, receiving a match request for a service request, and accepting a service request.

In example embodiments, the devices 110, 120 comprise mobile computing devices, smart phones, mobile phones, PDAs, phablets, tablets, portable computers, laptops, notebooks, ultrabooks, readers, electrical devices, media players, specialized devices (e.g., a dedicated or specialized device to communicate with and/or operate in the system 100, or parts thereof), smart speakers, digital assistants, a plurality of computing devices interacting together in part or in whole, and other specialized computing devices and industry-specific computing devices. The devices 110,120 described herein may also be wearable computing devices, including watches (such as the Apple Watch), glasses, etc. The device 110,120 may comprise a virtual machine, computer, node, instance, host, or machine in a networked computing environment. Such networked environment, or cloud, may be a collection of machines connected by communication channels that facilitate communications between machines and allow for machines to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

In some cases, user devices and service provider devices are of similar form, but this is not essential

Example 1:—Referring to FIG. 4C, geographical area 402f is forecasted to be in an over-supply state and geographical area 402k is forecasted to be in an over-demand state. A quantity M of excess available service providers may be forecast for geographical area 402f and a quantity N of required service providers may be forecast for geographical area 402k. If M>N, a quantity of N selected excess available service providers in geographical area 402f may be provided with a notification 121′ having a suggestion/request to move to geographical area 402k. On the other hand, if M<N, a quantity of M selected excess available service providers in geographical area 402f may be provided with a notification 121′ having a suggestion/request to move to geographical area 402k.

Example 2:—Continuing to refer to FIG. 4C, geographical area 402f is forecast to be in an over-supply state, geographical area 402g to be in a normal state, and geographical area 402h to be in an over-demand state. A quantity M of excess available service providers may be forecast for geographical area 402f and a quantity N of required service providers may be forecast for geographical area 402h. In this case, some service providers in area 402f are advised to move to area 402h, thus passing through area 402g. If M>N, a quantity of N selected excess available service providers in geographical area 402f may be provided with a notification 121′ having a suggestion/request to move to a particular location in geographical area 402h. On the other hand, if M<N, a quantity of M selected excess available service providers in geographical area 402f may be provided with a notification 121′ having a suggestion/request to move to a particular location in geographical area 402h. In a situation where a travel distance and/or travel time between geographical areas 402f and 402h is such that an excess available service provider may not or will unlikely travel from geographical area 402f to geographical area 402h to improve the available service provider's chances of being matched to a service request, an example embodiment “shares,” “divides,” or “breaks down” the travel distance or time among more than one available service provider (e.g., in a link or chain). In this case excess service providers in area 402f are advised to move to area 402g, and as long as there are available service providers in area 402g, some service providers from there are advised to move to area 402h.

It should be noted that it is not necessary for any area to be in a normal state for the teachings of this disclosure to be applicable. It is possible for example that in a case where area 402g and 402f are both in an over-supply state that service providers be advised to move from over-supply area 402g AND over-supply area 402f. It may be that a number of service provider in 402f are advised to move to area 402g to take the place of some, but not all, service providers from area 402g who have been advised to move to area 402h. It may be that service providers may move from an over supply area into an over demand area, but other service providers in that over demand area move on to another over demand area. It all depends on the forecast distribution of service providers how the system chooses to notify them.

It will be clear that the most service providers in any area who can be advised to move consists of the number of forecast service providers in that area; it is not possible to move more providers than exist. The general principle is that the aim is to create a better balance between supply and demand by advising certain available service providers in one or more locations of places where they can move to if an imbalance has been predicted or forecast, where such moving reduces the overall imbalance. Because forecast over-supply is liable to leave service providers without any job for periods of time, the service providers are likely to be motivated to follow such advice.

Dividing, breaking down, or sharing of the travel distance or time may improve the likelihood or chances of excess available service providers in geographical area 402f agreeing to move out of the “over-supply state” geographical area 402f. It is to be understood in the present disclosure that any quantity of intermediate geographical areas (e.g., intermediate geographical area 402g) may be used to achieve the optimization or balancing of supply-demand imbalance. It is also to be understood in the present disclosure that each intermediate geographical area (e.g., intermediate geographical area 402g) may be a geographical area having one or more portions physically located between an over-supply state geographical area (e.g., geographical area 4020 and over-demand state geographical area (e.g., geographical area 402h). Alternatively, or in addition, each intermediate geographical area (e.g., intermediate geographical area 402g) may be a geographical area having one or more portions physically located adjacent to an over-supply state geographical area (e.g., geographical area 4020 and/or over-demand state geographical area (e.g., geographical area 402h). Alternatively, or in addition, each intermediate geographical area (e.g., intermediate geographical area 402g) may be a geographical area that does not have one or more portions physically located between and/or adjacent to an over-supply state geographical area (e.g., geographical area 4020 and over-demand state geographical area (e.g., geographical area 402h).

Where M≥N, the quantity of N selected excess available service providers in geographical area 402f may be split to one or more other intermediate geographical areas as well, such as intermediate geographical area 4021 and/or intermediate geographical area 402b.

Where M<N, the quantity of M selected excess available service providers in geographical area 402f may be split (either evenly or unevenly) to one or more other intermediate geographical areas as well, such as intermediate geographical area 4021 and/or intermediate geographical area 402b.

Such splitting may be determined based on several factors including, but not limited to, a forecasted quantity of available service providers in one or more of the intermediate geographical areas, how many available service providers can be added into each of the intermediate geographical areas before the intermediate geographical area is forecasted to be in the over-supply state, etc.

Example 3:—Continuing to refer to FIG. 4C, area 402 is shown as forecasted over-supply. Areas 402b-d and 402p-r are forecast as normal and 402s is forecast over-demand The system calculates a forecast of M excess service providers in area 402a, whereas it forecasts N service providers needed in area 402s for a balance to occur.

If all M are needed from 402a to 402s, the system notifies all M service providers, in one embodiment. If only N service providers are required (N>M), then the system in one embodiment only notifies N service providers in area 402a. The notification is, as before, advice to move, in this case to area 402s, for example to a specific location in area 402s.

As will be seen by inspecting the drawing, to complete the move advised would involve driving through several “normal state” areas and service providers may be unwilling to drive such a long way. In one embodiment the balance state is improved by advising excess service providers in area 402a to move only to their next, or an intermediate area, for example area 402b or 402q, or maybe both. Then service providers in such intermediate areas are advised to move on, either directly to final area 402s, or to an intermediate area, for example 402c, 402r.

As noted previously, the aim is to improve the balance between forecast or predicted service providers and forecast or predicted service requests. It will be realized that the opposite side of this coin is that fewer service providers will lack work, and more service requests will be matched.

### Data Flow

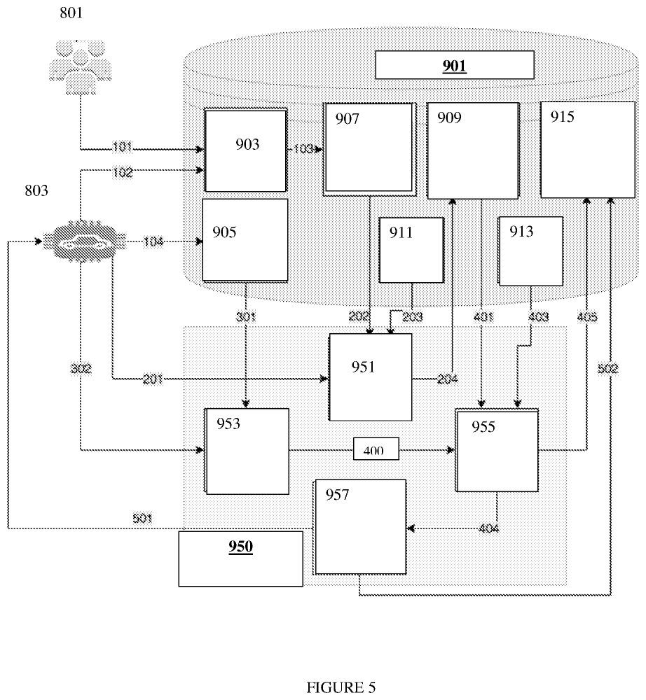

Referring now to FIG. 5, a block schematic view of an embodiment of data flow in part of the system 100 has a database, in this embodiment a data warehouse 901, and a processing arrangement 950 together forming a supervision/control set up.

This embodiment is described in the context of a ride hailing or taxi-like service but the invention is not limited to such a context. Examples of other applications will readily occur to the reader—for example goods pickup and delivery situations, public transportation, taxis, private car hires, limousine services, shuttles, ride-sharing, and delivery.

The embodiment described in the following is not intended to limit the scope of the invention. It will be apparent to the skilled reader that other arrangements will be possible.

The term “data warehouse” may need some explanation. The meaning in this specification is of a data store that stores data of different types or from different sources. It will be clear to the skilled person that other memory or storage systems may be used in other embodiments.

In general terms, the processing arrangement 950 consists in this embodiment of a processor running the instructions of a program stored in memory (not shown). The program causes the processor to provide the operations identified in this specification. In an embodiment, the processor performs other tasks as well, for example matching service requests with service providers.

The data warehouse 901 contains areas designated by their function, and in turn the function sets the nature of the data stored in each area. The areas include a service request and service providers data store 903, a service provider profile store 905, a historical demand and supply in area at time store 907 (referred to herein for simplicity as “a historical supply/demand store”), a forecast demand and supply in area at time store 909 (herein referred to as “forecast supply/demand store”), a third-party data store 911, a historical aggregated temporal-spatial data store 913 and a service provider receiving message store 915.

The processing arrangement performs four processes, namely a filter and selection process 953, a forecasting process 951, an optimization process 955 and a notification message process 957. The data warehouse is connected to receive service request data flows 101 from service requester devices 801, corresponding to user device 110 of FIG. 3, and pass data derived therefrom to the service request and service providers data store 903. Data flow 102 from service provider devices 803, corresponding to service provider device 120 in FIG. 3, flows to the service request and service providers data store 903 Data from here is extracted as flow 103 to the historical supply/demand store 907 of the data warehouse.

A data flow 104 from the service provider devices 803 passes to the service provider profile store 905, see FIG. 7.

Data flow from the service provider devices, or rather, due to the application running on those devices, is sent wirelessly for example via the Internet. The form of the data emitted by the service provider devices is, in an embodiment, as packets with headers indicating the destination of the packet and payloads carrying the fields needed for the operation of the system.

The service provider devices 803 also provide data flows 201, 302 respectively to the forecasting process 951 and the filter and selection process 953. A further data flow channel 501 is from the notification process 957 to each selected service provider 803, this time to allow outputs from the processing arrangement 950 to reach such selected service providers.

Data from the service provider profile store 905 is input to the filter and selection process 953 as data flow 301.

The forecasting process 951, along with data flow 201 from the service provider devices 803, also receives data 202 from the historical supply/demand store 907, and a third-party data store 911 of the data warehouse 901. The forecasting process 951 provides a data flow 204 to the forecast supply/demand store 909, and from there a data flow 401 to an optimization process 955. The optimization process 955 receives a data flow 400 from the filter and selection process 953, as well as the above-mentioned flow 401 from the forecast supply/demand store 909. It further receives a flow 403 from an historical aggregated temporal-spatial data store 913 of the data warehouse 950. It provides a data flow 406 to a service provider receiving message store 915 and a further data flow 404 to the notification message process 957.

The notification process message process 957 receives a data flow 502 from the notification message process 957.

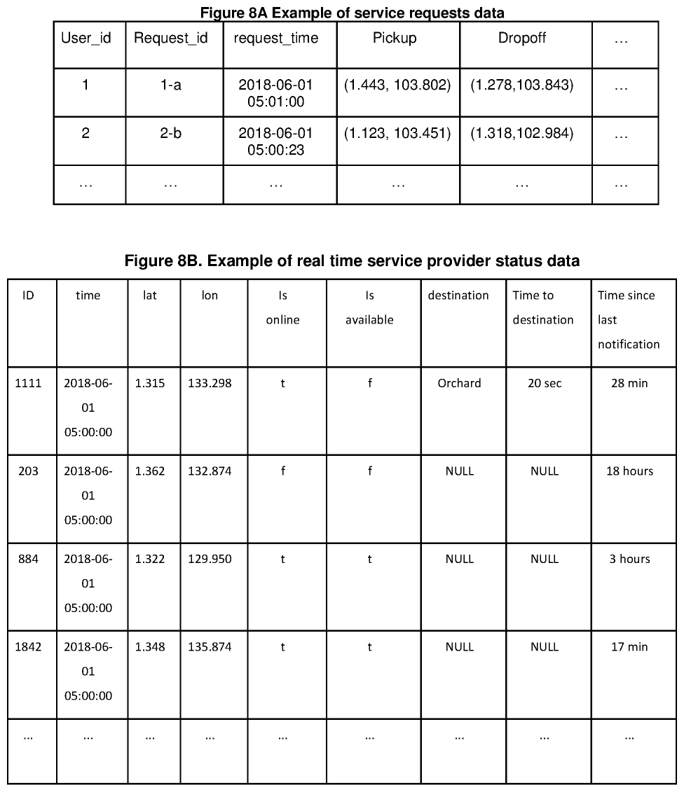

Data flow 101 is from the user communication device 801 (e.g. mobile phone) and is produced by an application running on the user's device when a user wishes to make a service request. The service requester's application outputs a message, typically wirelessly in the form of packets with headers indicating a destination (being the supervision/control setup in the current embodiment). The payload consists of service requester's (user's) information, and in one embodiment this comprises: user_id; request_id; request_time, pickup location, drop-off location, request time, hour of day, day of week, is_request_allocated, is_request_ignored; is_request_cancelled; is_request completed; fare; promotion. An example of data flow 101 is shown in FIG. 8A. The data flow 101 passes from the user device 801 via the communication network to the service request and service providers data store 903. In an embodiment, the service request information is only aggregated in a spatial-temporal format.

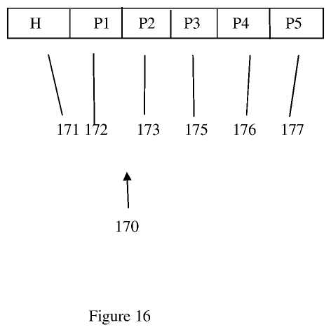

An example of part of a packet 170 is shown in FIG. 16, where section 171 is the packet header, and elements 172-7 are payload fields. For the above example of flow 101, payload field 172 carries “user_id”; 173 carries “request_id” and so on.

Data flows 102, 104, 201 and 302 are output from the service provider devices 803 running a service provider application. In one embodiment this application is configured to output (push) a message comprising at least one of the data flows each time a service provider interacts with his/her device 803. Also, in this embodiment if the service provider's device is operating, the application pushes an output on a regular basis, for example once per second. In another embodiment, the supervision/control unit pulls service provider data from the service provider application, as previously described, on a regular basis, for example once per second.

In some embodiments, if a service provider closes the application or turns off the device, no further data from that device is transmitted until the app is reopened. In this case the “GPS location” and “is available for service” are recorded as the location of the vehicle and the status of the service provider at its current timestamp (i.e. when the data was collected).

In one embodiment, the stores 905,907 are only updated using data from the data flows 102 and 104 originating at the service provider devices 803 on an occasional basis—for example once per day, once per week. This is because the data flows 102,104 contain data that is relatively invariant. Assume that there is a series data of service providers' location and availability all day long, an embodiment uses a snapshot at each 15 min (e.g. 5:00, 5:15, 5:30 and so on so forth) to approximate how many service providers (supply) are available at each geographical area for each 15 min time interval.

The service provider application responds to various stimuli, and also stores some permanent or semi-permanent data. The latter includes the ID of the service provider, for example. The former, i.e. changing data, includes such items as location, current availability, time to destination.

In an embodiment the input data flows from the service provider devices are:

Data flow 102: service_provider_id; is_available_for_service; GPS location (lat, lon). This data is output regularly, as noted above, in real time or near real time. If the service providers device is turned off or the application is disabled then the stored data by the data warehouse is the last data collected. The data otherwise is collected in real time but is not used directly as it needs preprocessing.

With data flow 101 and 102 the service provider status and location information are aggregated in a spatial-temporal format to provide a data flow 103, see below.

For example, for each service request (or service provider correspondingly), the pickup location (service provider location correspondingly) can be mapped by area. Demand is defined as the number of unallocated requests between start time and end time at the area, while supply is defined as number of available service providers between start time and end time at the area.

The table is stored as historical demand and supply in store 907, which serves as an input for forecasting engine 951.

Data flow 104: is service provider profile information, e.g. provider ID; service providers' average compliance rate (ACR); average online hours; average ride per week; is a taxi driver; age on platform; average acceptance rate; average cancellation rate. This data is aggregated at service provider level for recent past X weeks, X is configurable, for example 8 weeks to provide an aggregated output 301.

Data flow 201: Real time status data of service providers, comprising their current availability status; GPS (location); destination of current job if occupied; time to destination if occupied; time since service provider received his last notification.

Data flow 302: Real time data of service providers, comprising their current availability status, GPS, destination of current job if occupied, time to destination if occupied, time since service provider received his last notification.

### Historical Supply/Demand Store

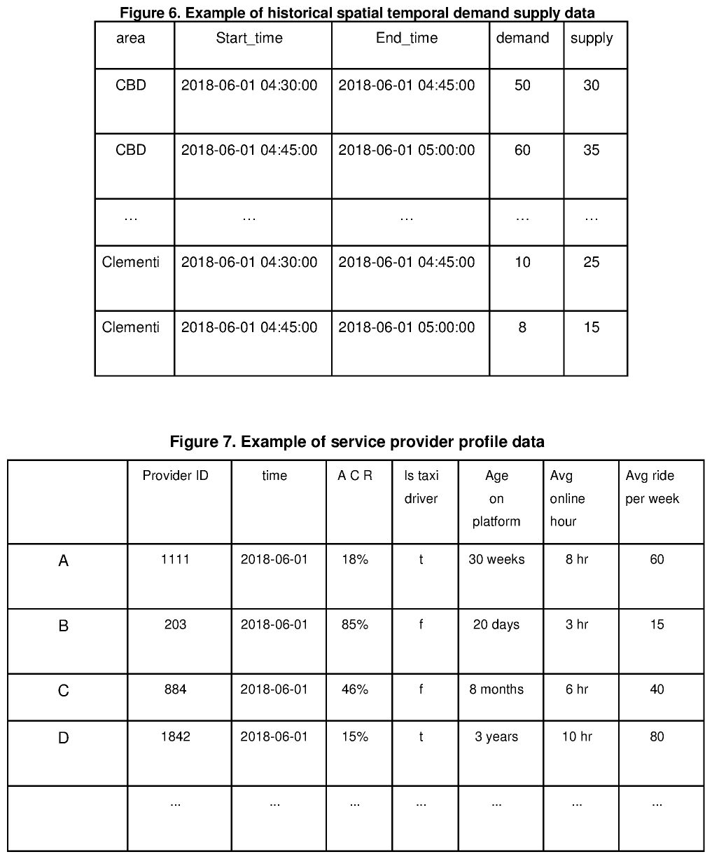

An example of the content of the historical supply/demand store 907 shown in tabular form is at FIG. 6. The data shown here forms the dataflow 202 to the forecaster process 951. It will be seen to include an indication of historical demand (number of service requests) and supply (number of service providers). As shown, there is evident imbalance in each zone.

In this specific case, the service provider status and location information are aggregated in a spatial-temporal format. The location is shown in the left hand-most column, here CBD (Central Business District), through to location “Clementi”. The time periods shown are for two 15-minute (past) periods (4:30-4:45 and 4:45-5:00). For each service request (or service provider correspondingly), it is possible to map the pickup location (service provider location correspondingly) by area.

The number of available service provider is counted at given timestamp (for example, end time).

This is because service provider availability status can switch during the 15 min time window. To allow for this the number of available service providers at the most recent timestamp is used as an approximation.

Demand is defined as number of unallocated requests between start time and end time at the area, while supply is defined as number of available service providers between start time and end time at the area. The table is stored as historical demand and supply.

An extract of the service provider profile store 905 contents in tabular form is shown in FIG. 7. Due to space constraints, not all columns are shown—other fields or data are likely to be collected and stored in other embodiments.

FIG. 7 shows four service providers, having identities as follows: 1111, 203, 884 and 1842. Of course, in a real-world situation it is unlikely that only four providers will be involved, but this number has been chosen here to ease explanation. These four providers will be used as examples throughout this document. For simplicity these will sometimes be referred to as shown in the Figure as providers A, B, C and D where A corresponds to 1111, B to 203, C to 884 and D to 1842.

Some comments on the data shown in FIG. 7: providers A and D are licensed taxi drivers. Providers B and C are not. Provider D has been using the system for the longest period (3 years) but has the lowest compliance rate—i.e. complies with the proposed service requests that are offered to him/her the least (only 15% of requests passed to him/her are fulfilled).

The data shown in FIG. 7 is relatively slow changing and is thus updated only occasionally in some embodiments.

### Forecasting Process

The forecasting process 951 has access to data flows 201, 202, 203.

Flow 201 is described above and shown in FIG. 8. In this embodiment it carries the same data as flow 302.

As will be seen, the latitude and longitude of each provider is shown in near real-time. Provider A is online (t=logical true) and is not available (f=logical false). Provider A has a destination of zone “Orchard” and it is estimated arrival time will be in 20 sec. A notification was sent (and retrieved by the app running on the providers device) 28 minutes ago.

Provider B is not online and is not available. Last notification was 18 hours ago.

Providers C and D are both online and available and thus have no destination.

Flow 202: Historical demand and supply data. Can use up to previous 8 weeks historical demand and supply data for each geographical area each selected time interval (for instance 15 min) See table 6, and the foregoing description of the store 907.

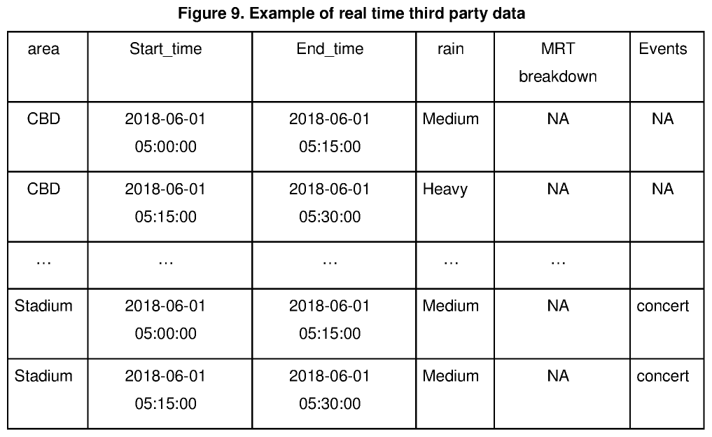

Flow 203 An example of the stored data in the third-party data store 911 in shown in tabular form in FIG. 9.

Third party data (such as weather conditions, big events, MRT (transport) breakdown news etc), most likely consumed in real time. For example, call API from weather company to get the real time weather conditions and/or forecasting weather conditions for next 15 min, Get mrt breakdown news from Twitter etc).

### Adopted Methodology:

From the historical supply/demand imbalance data in data flow 202 (FIG. 6), the forecaster process 951 uses Time Series forecasting techniques, such as Double Seasonal Holt-Winters (DSHW), AutoRegressive Integrated Moving Average (ARIMA) for demand and supply forecasting to predict what the imbalance would look like in one or more forthcoming time interval for each zone covered by the system.

Adding in data flows 201 (real time provider information) and 203 (third party information), allows the forecaster process 951 to use machine learning techniques, such as Recurrent Neural Networks (RNN), Long Short Term Memory (LSTM) etc for demand and supply forecasting.

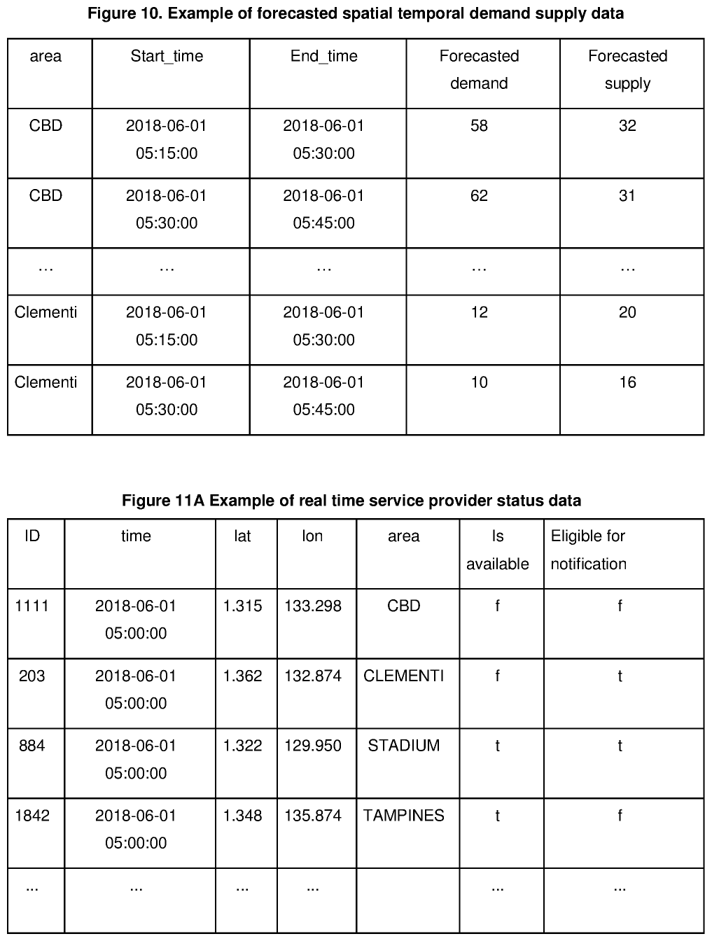

An example of the output data flow 204 of the forecaster process 951 to forecast supply/demand store 909 is shown in FIG. 10.

In the present embodiment supply and demand are predicted for each of plural geographical areas, for example for a set of areas or zones making up a city. The time period over which forecasting takes place can be varied, either as a standing time period, say 15 minutes for one city and 30 minutes for another city (depending on the traffic conditions or other parameters specific to the city) or a variable/selectable time period. By a “variable time period” is meant a time period that can be varied without any constraint. By “selectable time period” is meant that there is a population of time period values which are available for selection, so for example a 15 minute period might be selected during the middle of the day, but a 10 minute period for the rush hour, and a 30 minute period for the middle of the night. Periods may be time dependent, or may be adaptable, so that if demand is unusually low the system varies the period accordingly.

### Filter and Selection Process

The filter and selection process 953 receives data flow 302 (real-time data of service providers, such as their current availability status, GPS, destination of current job if occupied, time since service provider received his last notification.) and the service provider profile data flow 301 from the service provider profile store 905 (see FIG. 7).

The filter and selection process in an embodiment operates on the real-time data flow 302 with the following conditions: —
1) filter out service providers whose apps report the provider has received a “move” notification within certain period of time, for example half an hour;
2) Filter out service providers who are occupied and can't finish current job in certain period of time, for example 15 min;
3) Select service providers who are online and available for jobs;
4) Select service providers who are offline but potentially online soon based on supply forecasting;
5) Select service providers who are currently online not available for jobs but can be available soon based on supply forecasting;
6) Select service providers who are occupied but can complete job soon based on booking information and estimation.

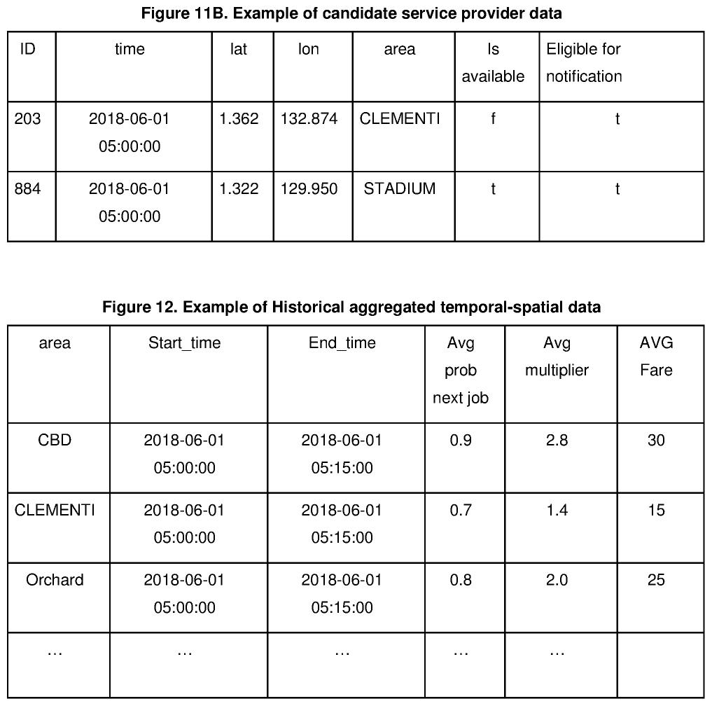

As noted, the filter and selection process 953 performs its processes on the real-time data flow 302 and an example of the results of the process are seen in FIG. 11A.

The service provider profile data 301 is used typically by the optimization process 955 to prioritise between service providers who have been selected. So, if two service providers are both selected for a single job by the selection process, the profile data will select one of the two ahead of the other—so for example a driver with a higher compliance rate will be chosen as a candidate provider over one who has a lower compliance rate. Also, some other parameters may be used from this data flow 301, for example: is the driver already a taxi driver before or not, is the driver a “new” driver etc. For taxi drivers, they may have the experience and knowledge of high demand locations and won't follow the notification. For “new” driver, he might not be clear about the demand pattern, so more guidance could be needed.

In one embodiment, the identities of the selected service providers are used by the filter and selection process 953 to grab data from profile data flow 301 so that profile information on each selected service provider is passed to the next stage (optimization) where prioritization can take place.

The dataflow 302 input is the same as the flow 201 shown in FIG. 8. From this it may be seen that provider A is close to his destination (20 sec) and could be available then. However, he received his last notification 28 min ago, hence he is filtered out. Provider D is currently idle and can be seen to be available for job. However, he received a notification 17 min ago, the logic of the process rules him out.

Provider B is currently off line and is not available but is not filtered out by conditions 1 or 2. He is not selected in by condition 3 or 5 (not online), nor by condition 9 (not occupied). He IS however selected in by condition 4. In this embodiment, historical data of when service providers went online (from offline) every day is stored. If it is found that service providers always go offline at certain time in certain area then notifications are sent to these service providers at appropriate times. (This is achieved by use of a machine learning model to predict the probability that a currently offline service provider with regular pattern will be online soon). The outcome of these logical operations on the data flow 302 is shown in FIG. 11A.

An example of the output data flow 400 is shown in FIG. 11B: This shows candidate service providers who are eligible for receiving notification to move around and their locations (lat, lon and the mapping to geographical areas). This data flow 400 is fed to the optimization process 955, As a further example, if a service provider is serving a booking request and far away from destination, he is not eligible for notification (condition 2). If service provider is serving a booking request and close to the destination (for example complete in 30 seconds), he will be eligible for notification (condition 6).

### Optimization Process

The optimization process 955 receives data flows 400, 401 and 403:

401: The forecasted demand and supply. See FIG. 10 and foregoing description, showing the imbalance per zone. This corresponds to a measure of the desirability of moving into a low supply area.

400: Candidate service providers who are eligible for receiving notification and move around and their current location. See FIG. 11B and above.

403: historical aggregated temporal-spatial data; such as average time or probability to find next job, average price multiplier (surge), average fare or average revenue for each geographical area in a given time period. Example as shown in FIG. 12.

FIG. 12 shows an example of the data flow 403 in a tabular form. This corresponds in some ways to the attractiveness to a service provider of different areas.

Using the data from these data flows, the optimization process:
i) Calculates the distance/time matrix of candidate service providers moving to each different geographical area from their current location based on the geographical area location, using the GPS data and candidate service providers current location GPS.
ii) Calculates the expected notification compliance probability matrix of candidate service providers moving to each geographical area, in other words an estimate of the likelihood that each candidate service provider will move if a notification were sent/received.
iii) Calculates the average probability to find next job matrix of service provider candidates moving to each different geographical area.
iv) Calculates the expected revenue matrix of service provider candidates moving to each different geographical area.

The optimization process can be set to have one or more objectives selected from

a) Minimize the total supply-demand imbalance for the whole area (country, city etc)

b) Minimize the total driving distance for all service provider candidates

c) Minimize the average time to find next job for all service provider candidates

d) Maximize the average probability to find next job for all service provider candidates

f) Maximize the expected revenue for all service provider candidates after redistribution

Constraints include:
i) Each service provider candidates' driving distance does not exceed his own willingness to move distance threshold (derived from historical data).
ii) Each service provider candidates' is not sent to more than N geographical area (We provide N potential destination for service provider candidate to choose from)
iii) Not possible to send more than the number of available service provider candidate in each geographical area

The optimization process 955 can be refined in some embodiments to allow for prioritization one or more of:

Service providers with high notification compliance rate.

New signup non-taxi service providers who are not familiar with the whole picture of the supply demand.

Active service providers with long idle time and very short offline time since last completion.

The supply redistribution problem basically falls into the category of resource allocation problem. This problem typically is formulated in mixed-integer programming, and it has been proved that this redistribution problem can be formulated as a minimum flow cost problem equivalently. Other formulations such as linear regression or bipartite graph (network) are also applicable.

To solve the mathematical model, it requires specific optimization skills and knowledge, rather than random guess. For a mixed-integer programming, Branch & Bound algorithm is an alternative and basic option. Since the minimum cost flow problem can be solved as a linear programming, any relevant algorithm could be applied to it.

### Output:

In general, the output of the model is a matrix consists of 0 and 1. “0” indicates that a service provider candidate is not relocated to a particular area, and vice versa.

If the corresponding outputs of a service provider candidate are all zero value, this candidate will not be notified.

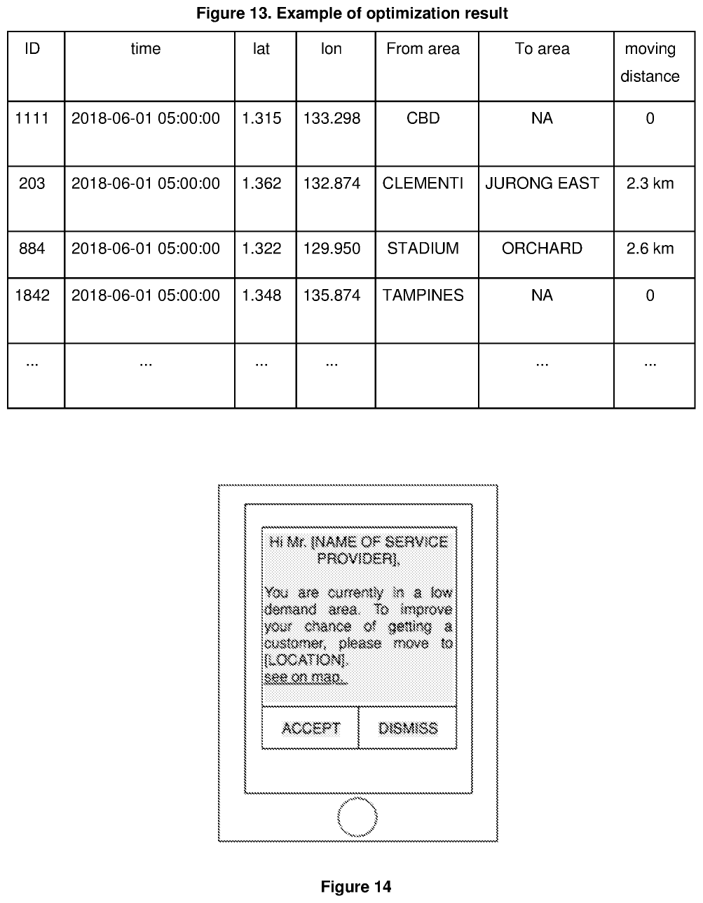

An example of the process of optimization is seen in FIG. 13. Referring to this figure, it will be seen that Provider A is not notified to move; Provider B is notified to move from present location “Clementi” to area “Jurong” East; Provider C is notified to move from “Stadium” to “Orchard”, and Provider D receives no notification so remains in area “Tampines”.

The result is made available to service provider received message store 915 as dataflow 405 and made available to the notification message process 957 as dataflow 404.

The notification message process 957 receives Input data flow 404 (the optimization result). It generates an output to ONLY those providers (here B and C), notifying them of the recommendation to move. Each provider who is to be notified with that recommendation receives only a message customized to him/her. This is auto-generated and emitted to relevant service provider devices with to area=not null.

The application on the service provider devices receives the outputs of the notification process 957 and creates from it a message. This, for example, could be a message displayed on the GUI of the service provider device as shown in FIG. 14. This message has three interactive areas, where user interaction can be made—for example pressing a touch screen, or similar.

Pressing “See on map” will show the suggested destination to service provider in the map in his navigation system.

Press “Accept” button, it will direct to the navigation system with suggested routing to the destination.

Pressing “Dismiss” button is used for service provider to ignore the notification if they are not interested in the recommended destination.

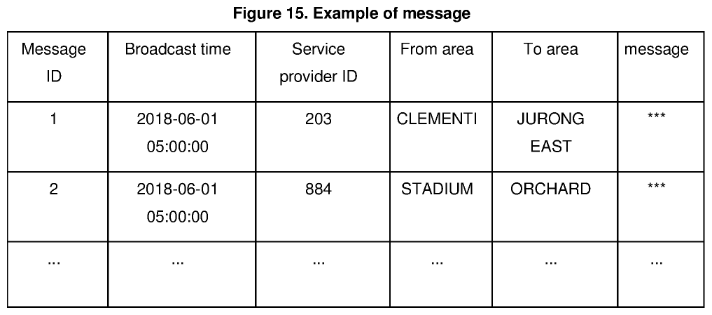

Message content is supplied via data flow 502 to is service provider receiving messages tore 915 where storage takes place—see FIG. 15.

The content of the message can be used for A/B test to verify whether the notification text can make a difference in shaping service providers' behaviour in terms of compliance.

In another embodiment, the message could be a spoken message. In yet another both a textual and a spoken or other audible message are provided.

It should be noted that the specific details of the data flows described above are merely embodiments of such flows. Other embodiments may exist in which additional or alternative data flows are used, or where the discussed dataflows contain alternative or additional fields.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A method of managing transport service providers, the method comprising:—
a provider data receiving step of receiving, in real time, a first data flow, the first data flow comprising data indicative of each of plural service providers, the data comprising an indication of the identity of each service provider, availability data of the respective service provider and an indication of the real time location of each the respective service provider;
a forecasting step of processing the first data flow and stored historical supply/demand data to provide a forecast of the number of service providers and number of services requests over an area comprising plural geographical zones, wherein the forecast is by zone;
a filter step of using availability criteria to filter out service providers from the first data flow to output data indicative of a set of candidate service providers who are eligible on the basis of the availability criteria for receiving notifications to move around, wherein the data indicative of each eligible candidate service provider includes an indication of the identity of each eligible candidate service provider associated with a location of the respective candidate service provider;
an optimization step of combining the data indicative of the set of candidate service providers eligible on the basis of the availability criteria with the forecast number of service providers and number of service requests and calculating there-with a matrix comprising data values for distance and time of candidate service providers moving to each different zone from their current zone, thereby to establish a subset of candidate service providers eligible on the basis of the availability criteria and on the basis of one or more of distance and time to be moved from their current zone to a respective new zone; and
a notification step of outputting a respective notification to only each candidate service provider of the subset, the notification comprising a message customised to the respective service provider and indicating a new location in a new zone, whereby the number of service providers in at least some zones converges on the number of service requests.

2. The method of claim 1, further comprising receiving in real-time a request data flow comprising at least some of data indicative of a requester, time of request, pickup location and drop off location.

3. The method of claim 1 further comprising:—
receiving in real time a request data flow having at least some of data indicative of requester, time of request, pickup location and drop off location and;
storing data from said request data flow and the first data flow.

4. The method of claim 1, further comprising processing received service request data, the service provider status and location information and storing the result as historical demand and supply data.

5. The method of claim 1, wherein the forecasting step comprises applying a forecasting process to historical supply and demand imbalance data to predict what the imbalance would look like in one or more forthcoming time intervals for each zone covered by the system.

6. The method of claim 5, wherein the forecasting process employs one of Time Series forecasting techniques, such as Double Seasonal Holt-Winters (DSHW), AutoRegressive Integrated Moving Average (ARIMA) for demand and supply forecasting.

7. The method of claim 5, wherein the forecasting step comprises using machine learning techniques, such as Recurrent Neural Networks (RNN), Long Short Term Memory (LSTM) etc for demand and supply forecasting.

8. The method of claim 7 wherein the forecasting step additionally comprises using data from a third party data store storing externally supplied data.

9. The method of claim 1, wherein the optimization step comprises receiving forecasted demand and supply data, data indicative of the identity of candidate service providers and: historical aggregated temporal-spatial data.

10. The method of claim 9, wherein the historical aggregated temporal spatial data comprises at least one of average time or probability to find next job, average price multiplier (surge), average fare or average revenue for each geographical area in a given time period.

11. The method of claim 1, wherein the optimization step calculates one or more of:
i) the expected notification compliance probability matrix of candidate service providers moving to each geographical area;
ii) an “average probability to find next job” matrix of service provider candidates moving to each different geographical area; and
iii) an “expected revenue” matrix of service provider candidates moving to each different geographical area.

12. The method of claim 1 wherein the optimization step is controllable to achieve one or more objectives selected from
i) minimize the total supply-demand imbalance for the whole area (country, city etc.);
ii) minimize the total driving distance for all service provider candidates;
iii) minimize the average time to find next job for all service provider candidates; and
(iv) maximize the average probability to find next job for all service provider candidates.

13. Apparatus for managing transport service providers, comprising data storage and a processor operating under control of stored instructions to:—
receive, in real time, a first data flow, the first data flow comprising data indicative of each of plural service providers, the data comprising an indication of the identity of each service provider, availability data of the respective service provider and an indication of the real-time location of each the respective service provider;
read, from the storage, historical supply/demand data process the first data flow together with the historical supply/demand data to provide a forecast of the number of service providers and number of services requests over an area comprising plural geographical zones, wherein the forecast is by zone;
filter the first data flow using availability criteria to filter out service providers from the first data flow to output data indicative of a set of candidate service providers who are eligible on the basis of the availability criteria for receiving notification to move around, wherein the data indicative of each eligible candidate service provider includes an indication of the identity of each eligible candidate service provider associated with a location of the respective candidate service provider;
combine the data indicative of the set of candidate service providers eligible on the basis of the availability criteria with the forecast number of service providers and number of service requests and calculate therewith a matrix—comprising data values for distance and time of candidate service providers moving to each different zone from their current zone, thereby to establish a subset of candidate service providers eligible on the basis of the availability criteria and on the basis of one or more of distance and time to be moved from their current zone to respective new zone; and
output a respective notification to only each candidate service provider of the subset, the notification comprising a message customized to the respective service provider and indicating a new location in a new zone, whereby the number of service providers in at least some zones converges on the number of service requests.

14. A computer program or computer program product comprising instructions for implementing the method of claim 1.

15. A non-transitory storage medium storing instructions, which when executed by a processor cause the processor to perform the method of claim 1.
